(19) United States
(12) Patent Application Publication
(10) Pub. No.: US 2010/0333004 A1
(43) Pub. Date: Dec. 30, 2010

(54) METHOD, APPARATUS AND SYSTEM FOR MODIFYING A COMPOSITE VIDEO SIGNAL

(75) Inventors: Ivan Marius KRISTIANSEN, Oslo (NO); Vegard Hammer, Oslo (NO); Geir Bjune, Hovik (NO)

Correspondence Address: OBLON, SPIVAK, MCCLELLAND MAIER & NEUSTADT, L.L.P., 1940 DUKE STREET, ALEXANDRIA, VA, 22314, US

(73) Assignee: Tandberg Telecom AS, Lysaker (NO)

(21) Appl. No.: 12/821,198

(22) Filed: Jun. 23, 2010

Related U.S. Application Data
(60) Provisional application No. 61/220,023, filed on Jun. 24, 2009.

(30) Foreign Application Priority Data
Jun. 24, 2009 (NO) 20092407

(51) Int. Cl. H04N 7/15; G06F 3/048; G06F 9/46

(52) U.S. Cl. 715/765; 348/14.12; 719/328

(57) ABSTRACT

A method for modifying a composite video signal generated by a video composing server, the composite video signal including a plurality of spatially mixed video conference streams. The method includes displaying, on a touch screen, a graphical representation of the composite video signal, and modifying the graphical representation based on an input received at the touch screen. In turn, the composite video signal is modified to conform with the modified graphical representation.

### CROSS-REFERENCE TO RELATED APPLICATIONS

This application claims the benefit of priority of Provisional Application Ser. No. 61/220,023, filed Jun. 24, 2009, and claims the benefit of priority under 35 U.S.C. §119 from Norwegian Patent Application No. 20092407, filed Jun. 24, 2009, the entire contents of both of which are incorporated herein by reference.

### FIELD OF INVENTION

The invention relates to a touch screen control system for a video conferencing system, and more specifically a method and device for modifying the layout of a composite video signal generated by a video composing server.

### BACKGROUND

Conventional videoconferencing systems comprise a number of end-points communicating real-time video, audio and/or data (often referred to as duo video) streams over and between various networks such as WAN, LAN and circuit switched networks.

A number of videoconference systems residing at different sites may participate in the same conference, most often, through one or more Multipoint Control Units (MCU) performing e.g. switching and mixing functions to allow the audiovisual terminals to communicate properly.

An MCU may be a stand alone device operating as a central network recourse, or it could be integrated in the codec of a video conferencing system. An MCU links the sites together by receiving frames of conference signals from the sites, processing the received signals, and retransmitting the processed signals to appropriate sites.

In a continuous presence conference, video signals and/or data signals from two or more sites are spatially mixed to form a composite video signal for viewing by conference participants. The composite video signal is a combined video signal that may include live video streams, still images, menus or other visual images from participants in the conference. There are unlimited number of possibilities of how the different video and/or data signals are spatially mixed, e.g. size and position of the different video and data frames in the composite image. A Codec and/or MCU typically have a set of preconfigured composite video signal templates stored on the MCU or video conference codec allocating one or more regions within a composite video signal for one or more video and/or data streams received by the MCU or codec. The different compositions of the composite video signals are hereafter referred to as layouts.

Typically all conference attendees receive the same layout, however some MCU's allow attendees to select their own personal layout. The conference owner chooses the layout before the conference starts. The layout may be changed during a video conference by the conference owner.

Known video conferencing systems generally allow users to choose layout in two ways. One way is to choose a layout in a video conferencing management system (VCMS). A VCMS is a network device configured to schedule conference calls and manage/configure video conference devices. A VCMS typically provides a web based user interface where a user can select the preferred layout for a scheduled conference or an ongoing conference. Another way to select a layout is by using a standard input device, such as a keypad on a remote control or a mouse. The latter is typical for video conference systems with embedded MCU's. However, common for both methods is that the user can only choose one of a set of preconfigured type of layouts, e.g. continuous presence (all participants present on the screen) or voice switched (the speaker covers the entire screen). FIG. 1 illustrates a set of typical continuous presence layouts. Further, known methods of changing layout during a call require a user to be familiar with the video conferencing systems on-screen menu's and often require several iterations through the menus by pushing buttons on a remote control, which makes it cumbersome and distracting.

Today, users of technical installation are accustomed to and demand systems which are easy to use and provide flexibility in ways of customization of graphical environments and collaboration between devices. Traditional video conferencing systems are not very flexible. For example, regardless of layout selected by a user when initiating a continuous presence and/or a Duo Video call, the order, positions and sizes of the different video and/or data stream in the composite image is beyond the user's control. Further, traditional video conferencing systems are operated using on-screen menu systems controlled by a keypad on an IR remote control device, allowing for limited flexibility and cumbersome user experience.

### SUMMARY

It is an object of the present specification to provide a device and method that eliminates the drawbacks described above.

In one embodiment, the specification discloses a device and method for modifying a composite video signal generated by a video composing server, by providing, on a touch screen, a graphical representation of the composite video signal, modifying the graphical representation using the touch screen and modifying the composite video signal to conform with the modified graphical representation.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a schematic overview of typical continuous presence layouts;

FIG. 2 is a schematic overview of a touch screen control system;

FIG. 3 is a block diagram of one embodiment of the present invention;

FIG. 4 is a schematic overview of one exemplary embodiment of the present invention;

FIG. 5 is a schematic overview of another exemplary embodiment of the present invention;

FIG. 6 is a schematic overview of another exemplary embodiment of the present invention;

FIG. 7 is a flow diagram illustrating the method according to the present invention; and

FIG. 8 illustrates a computer system upon which an embodiment of the present invention may be implemented.

### DETAILED DESCRIPTION

In the following, the present invention will be discussed by describing various embodiments, and by referring to the accompanying drawings.

One embodiment relates to a method and device for modifying the image layout of a composite video signal (e.g. duo video or continuous presence video conference). A layout control unit according to this embodiment may be end user component that presents graphical representation of the current video composition to the user, and allows the user to manipulate the composition using the touch screen.

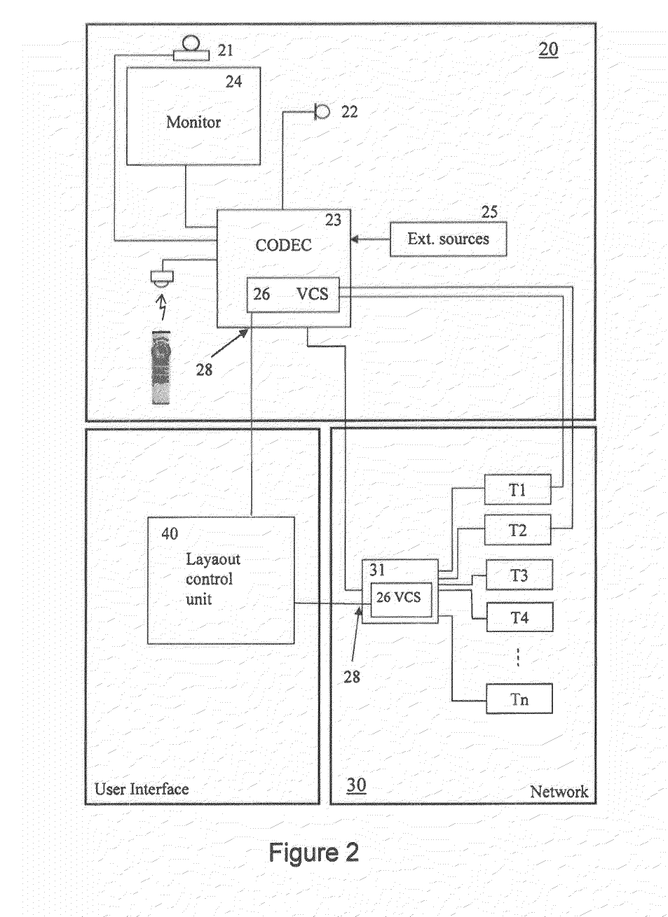

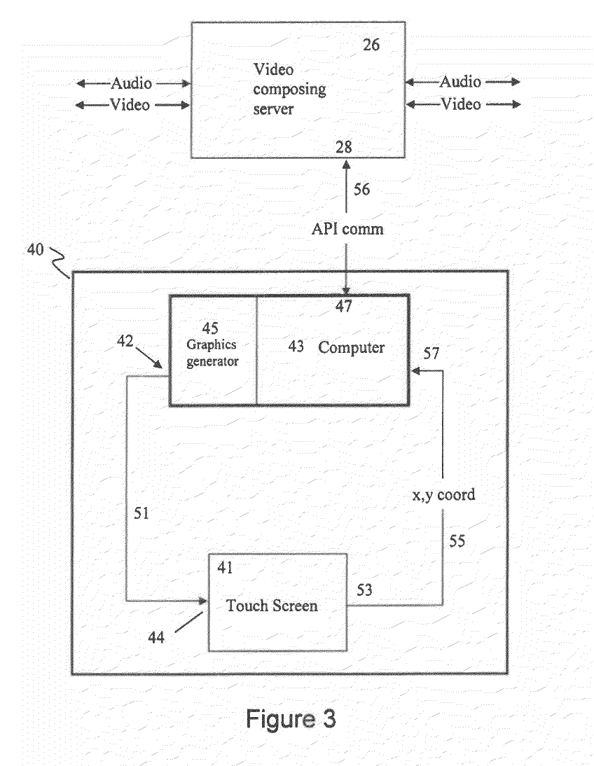

Reference is first made to FIGS. 2 and 3. With particular reference to FIG. 2, a video conferencing system is generally designated by the reference numeral 20. The system 20 includes a camera 21 and a microphone 22 supplying video and audio signals to a CODEC 23, which supplies audio-video signals to one or more monitor(s) 24. The CODEC 23 may also be supplied with signals from external multimedia sources 25, e.g. VCR's, DVD players, document cameras, personal computers, etc. The CODEC 23 may receive data signals (e.g. video, audio, still images, etc) from the external sources to be displayed on the monitor(s) 24, and/or the signals from the external sources may be sent to other video conferencing systems (T1-Tn) connected to the video conferencing system 20 via a network 30.

The codec 23 may have an embedded MCU configured to send/receive conference signals (audio/video/data streams) to/from video conferencing systems (T1-Tn) over a network 30. Alternatively, the CODEC 23 may connect to a centralized MCU 31 via a network 30. An MCU links sites together by receiving frames of conference signals from the sites, processing the received signals, and retransmitting the processed signals to appropriate sites.

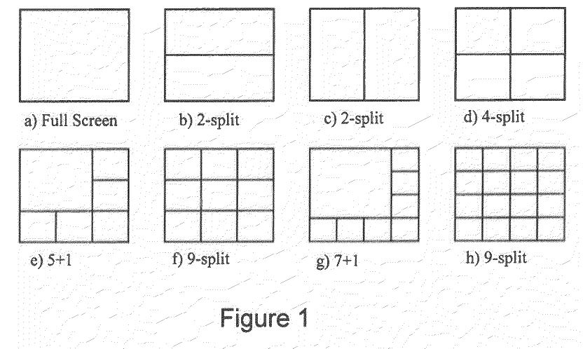

An MCU includes at least a Video Composing Server (VCS) 26 that spatially mixes video signals and/or data signals from two or more video conferencing system to form a composite video signal (see FIG. 1 for typical configurations of composite video signals) for viewing by conference participants. The video signals and data signals are also referred to as video conference streams.

According to one embodiment of the invention, the VCS 26 has an Application Programming Interface (API) that allows users to programmatically change the video composition according to personal preferences using a layout control unit 40. With further reference to FIG. 2, API communications between the layout control unit 40 and the video composing server 26 are exchanged via a port 28 in the video composing server 26 and a port 47 in the layout control unit 40. This interface accessed via the port 28 allows for communication with the VCS 26, so that the layout control unit 40 according to the present invention can provide the VCS 26 with a desired series of commands and receive responses from the VCS 26.

According to one embodiment, the VCS 26 is part of an MCU embedded in a CODEC 23 of a video conferencing terminal, and where the VCS 26 has a port 28 in the CODEC for exchanging API communication.

According to another embodiment, the VCS 26 is a network device or part of a network device, such as a centralized MCU 31, and includes a port 28 for exchanging API communication.

With reference to FIG. 3, the components of the present invention are generally designated by the reference numeral 40 and are seen to comprise a touch screen unit 41, a personal computer 43 and a graphics generator 45. The graphics generator may be part of the computer 43, or may also be a separate computational device connected to the computer 43. As seen, the personal computer 43 has a port 47 to which is coupled a communication link 56 coupled to the API communications port 28 of the VCS 26.

The touch screen 41 comprises an LCD screen or other video display technology (CRT, OLED, Plasma, etc.) that can be of varying size. In addition to the display screen, the touch screen 41 contains hardware that overlays the display screen with a matrix of x and y coordinate detectors. When an object applies pressure (touch) to the touch screen, it transmits a command to the computer 43 indicating the x and y coordinates of the point where the pressure was applied.

The layout control unit 40 communicates with the VCS 26 using the previously mentioned API. The communication between the VCS 26 and the layout control unit comprise commands at least comprising a layout configuration. The layout configuration describes the composition of a layout. The layout configuration at least identifies the size and position of areas (or frames) for displaying a video or data stream, and a video/data source ID identifying the stream to be displayed in a given area (or frame).

In response to receiving a layout configuration from the VCS 26, the graphics generator 45 under control of the personal computer 43 provides to the touch screen 41 via a port 42 a graphical representation of the current composite video signal (layout) generated and output by the VCS 26. The graphical representation includes graphical objects, where an object represents a video stream or data stream in the composite video output by the video composing unit. The graphical representation may comprise a visible boundary line to illustrate to the user the total available area of the composite video signal. Alternatively a boundary line is not visible in the graphical representation, but the user is alerted (given a visual cue) if a user is trying to drag or place objects outside a non-visible boundary line. The video and/or data stream in the composite video signal and the graphical objects in the graphical representation are arranged in a corresponding order and in corresponding relative positions and sizes.

According to one embodiment, the graphical objects are images illustrating the content of the video and/or data streams (video conference streams) the graphical objects represent. The image may be an outline of one or more persons, a computer generated image, a photograph, text describing the content (name of participant, name of video conferencing system, “presentation”, “movie”, etc), a screen shot from the video conferencing system or computer providing a video/data stream, or a combination of two or more of the above. According to another embodiment, the graphical objects are movie clips, animations or live video feed from a video conferencing system or an external source.

When a user touches the screen of the touch screen system 41 with an object (e.g. finger or stylus), the x and y location coordinates corresponding to the location of the object touching the screen are transmitted to the computer 43 and graphics generator 45 via the port 53, the conductor 55 and a port 57 on the computer 43. If a user touches coordinates within an area on the screen displaying one of the graphical objects, the user may manipulate the object by performing certain gestures on the touch screen.

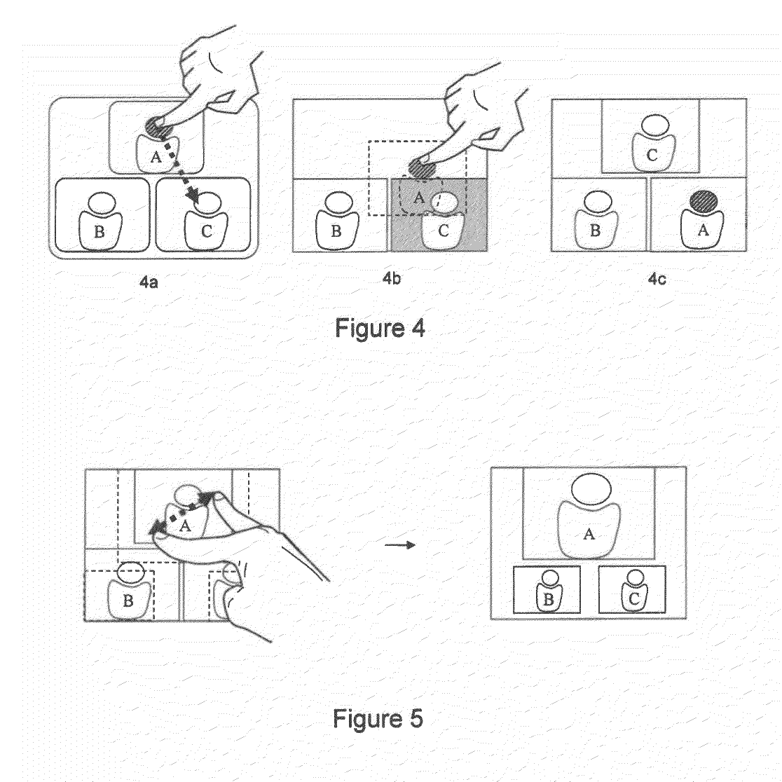

According to one embodiment, the user may rearrange the order of the graphical objects by dragging and dropping objects in the graphical representation on the touch screen. Two objects switch place when one object is dragged and dropped onto another object in the graphical representation, as illustrated in FIGS. 4a-4c.

According to another embodiment, the user may modify the position of the graphical objects by dragging and dropping the objects onto arbitrary position within the boundary line. The boundary line represents the total available area in the composite video signal generated by the VCS 26. In other words, the boundary line represents the image displayed to a user on a display 24.

According to yet another embodiment, the user may resize the graphical objects. The resizing may be performed by applying a gesture recognized by the computer 43, e.g. by applying a pinching movement of two or more fingers while continuously applying pressure to the touch screen over a graphical object, as illustrated in FIG. 5a. According to yet another embodiment, when a user is resizing a graphical object, the graphics generator will automatically adapt the size of the other graphical objects in the graphical representation to avoid overlap of the graphical objects, as illustrated in FIGS. 5a-5b.

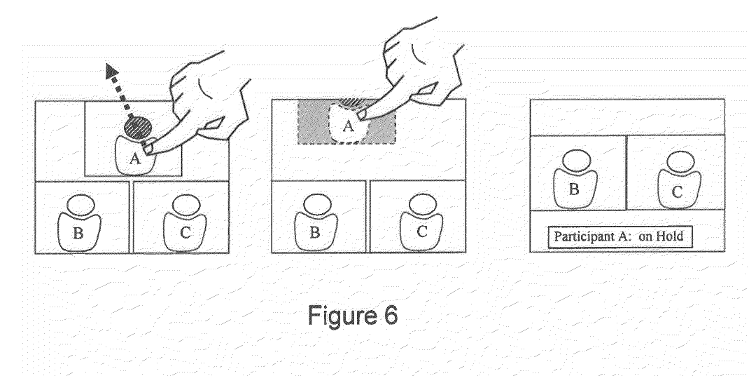

According to yet another embodiment, the user may remove an object from the graphical representation to allow more space for the remaining objects. The removal of an object may be performed by dragging and dropping an object or parts of an object outside the boundary line or the edge of the screen, as illustrated in FIGS. 6a-6c. The stream represented by the removed object may remain in the call (but will not be displayed), or the conference call represented by that graphical object is placed on hold or may be disconnected from the call. The user may modify the remaining objects according to liking, or the graphics generator may modify the remaining objects automatically to best fit within the boundary line.

Next, when the user has modified the graphical representation on the touch screen by manipulating the graphical object(s) according to one or more of the embodiments above, the computer 43 transmits a command (or signal) comprising a layout configuration describing the modified graphical representation to the VCS 26 via the port 47, the communication link 56 and a port 28 on the VCS 26. In response to the received layout configuration from the computer 43, the VCS 26 modifies the composition of the composite video signal according to the layout configuration, and hence in accordance to the modified graphical representation on the touch screen.

According to one embodiment, a layout configuration is automatically sent to the video VCS 26 if the computer 43 or graphics generator 45 detects a modification in the graphical representation (e.g. modification in positions, sizes, etc.).

According to another embodiment, a layout configuration is only sent to the VCS 26 upon request/confirmation from a user. This allows a user to redesign and review the layout before instructing the VCS 26 to modify the video composition. This is especially useful in a situation where the graphical objects are live video feed(s) from a video conferencing systems or a external source 25, allowing the user to experiment using different layouts with the actual video and/or data streams, giving a realistic preview of the layout before accepting or rejecting changes.

According to one embodiment, the layout control unit is a dedicated device. The dedicated device may be a default part of the video conferencing system, or be an add-on device acquired separately.

According to another embodiment, a portable computing device, such as a personal digital assistant, mobile phone, laptop computer or similar portable computing device having a touch screen interface and a communication interface supported by the VCS 26 (e.g. TCP/IP), may be utilized as the layout control unit. A client software (layout control client) may be downloaded and/or installed on such a portable computing device enabling the portable computing device as a layout control unit as described herein.

The computer 43 in the layout control unit 40 may include a processor and a memory medium(s) on which one or more computer programs or software components according to one embodiment of the present invention may be stored. For example, the graphics generator to be deployed may be stored on the memory medium of the computer 43. Also, the memory medium may store a graphical programming development application used to create the graphics generator, as well as software operable to convert and/or deploy the graphics generator on the portable computing device. The memory medium may also store operating system software, as well as other software for operation of the computer system.

FIG. 3 is similar to FIG. 2, but focuses on the components of the present invention as explained above. Like reference numerals in FIG. 3 refer to like components in FIG. 2. The system 40 permits control of the VCS 26 through the use of the easy-to-use touch screen 41 which is controlled by the personal computer 43, an intelligent device that ensures logical operation, may give users second chances through display of a request to verify that a correct choice has been made, and guards against erroneous operations.

In more detail, the computer 43 is capable of executing logical instructions written in a computer programming language. The computer 43 controls operation of the VCS 26 via a PCI or other appropriate bus physically installed in the computer 43; with the VCS 26 via a communication link 56 schematically represented in FIG. 3. According to one exemplary embodiment, the communication between the computer 43 and the VCS 26 is exchanged using TCP/IP over communication link 56. Communication link 56 may be a wired or wireless link, such as PAN, CAN, MAN, LAN, WLAN, WAN, etc. The communication between the video composing Server 26 and the computer are commands that go back and forth between the port 47 of the computer 43 and the port 28 of the CODEC/VCS 26. As should be understood, these communications conform to the manufacturer's API of the VCS 26.

Communications also occur using the touch screen 41 via a communications link shown in FIG. 3 and designated by the reference numeral 55 for the conductor and 53 and 57 for the ports. Images from the graphics generator 45 are transferred to and displayed on the touch screens display via port 42, conductor 51 and port 44.

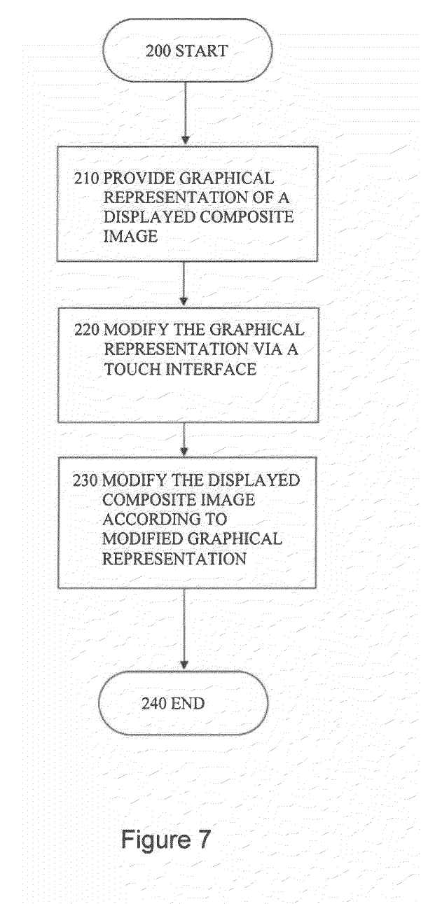

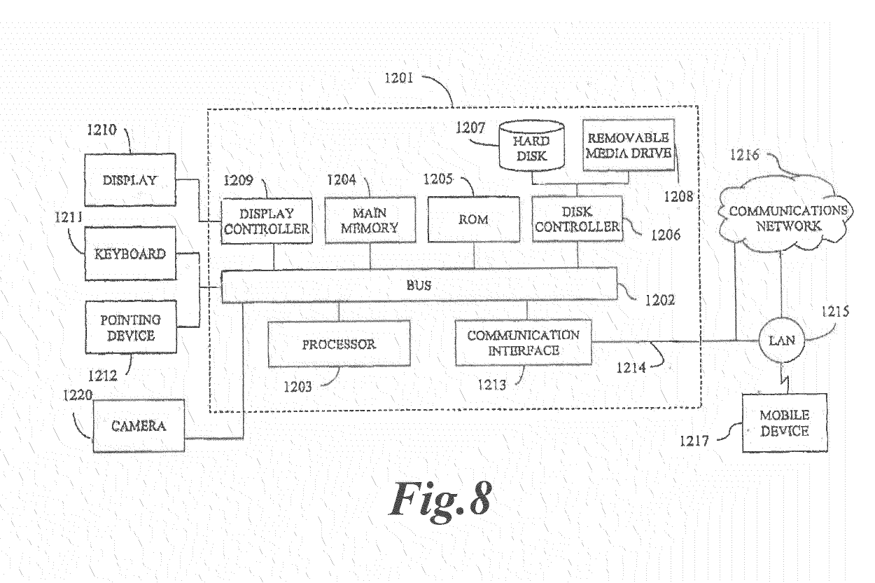

With reference to FIG. 7, all communication between the VCS 26 and the computer 43 follows a similar procedure. When predefined events occur, the VCS 26 starts 200 by sending a command/signal to the computer 43, at least comprising a layout configuration defining the video composition currently used by the VCS 26. This predefined event may include: when a video conference is started, when the video composition is changed, when a layout control unit connects to the VCS 26 during a conference, on request from the layout control unit, etc. For example, a user D calls participant A, participant B and participant C using a video conferencing system as illustrated in FIG. 2. The VCS 26 generates a composite video signal as shown in FIG. 6a. The video conferencing system is already connected to a layout control unit, and when the conference starts the VCS 26 sends a command to the computer 43, identifying at least the position, size and ID of each video/data stream via a layout configuration.

Next in step 210, the graphics generator creates a graphical representation of the current video composition used by the VCS 26, based on the received layout configuration. As described above, the graphical representation comprises a graphical object for each video/data stream in the composite video signal, where the relative positions and sizes of the graphical objects correspond to the relative positions and sizes of the video/data streams in the composite video signal. The graphics generator sends the graphical representation (image) to the touch screen 41 via the port 42, communication link 51 and port 44 on the touch screen 41.

Next in step 220, a user can modify the graphical objects in the graphical representation by touching the touch screen 41 and performing finger gestures on the touch screen 41 as described in more detail above. Responsive to that touching, the touch screen 42 transmits the x and y coordinates of the touched area or areas to the computer 43 via port 53, communication link 55 and port 57. The computer 43 and the graphics generator process the information from the touch screen and update the graphical representation, and hence the image displayed on the touch screen, live.

Next in step 230, if the computer and the graphics generator detects that one or more of the objects have been modified, the computer 43 sends a command to the VCS 26, at least comprising a layout configuration identifying the new position(s) and size(s) of the modified object(s). According to one embodiment, a command comprising a layout configuration defining the position and sizes of all the graphical objects in the modified graphical representation is sent to the VCS 26, even if modifications only are made to one object. In response to the received command (layout configuration) from the computer 43, the VCS 26 modifies the composite video signal to correspond to the new layout defined by the graphics generator.

In a final step 240, the VCS 26 sends an action completed signal to the computer 43 via the port 28, communication link 56 and port 47. Once the action has been completed in the manner described above, the computer 43 awaits indication of a next touch of the screen 41 by the user.

According to one embodiment, the layout configuration described above is an XML document defining the position, size and ID of all the streams in the layout. An exemplary XML document according to one embodiment of the present invention may look like this:

<video>

<layout>

<frame item=1>

<PositionX>10000</PositionX>

<PositionY>10000</PositionY>
<Width>4084</Width>
<Height>4084</Height>
<VideoSourceId>1</VideoSourceId>

<frame item=2>

<PositionX>5000</PositionX>

<PositionY>5000</PositionY>
<Width>4084</Width>
<Height>4084</Height>
<VideoSourceId>2</VideoSourceId>

Video signals and/or data signals from two or more video conferencing systems are spatially mixed to form a composite video signal. The area occupied by a video or data signal is referred to as a frame. When the VCS 26 mixes the video and/or data signals it needs to know the exact position and size of each frame. Therefore, the layout configuration at least defines the position, size and an identifier identifying the video/data source, for each frame. Referring to the exemplary XML document above, the <position> of the different frames that make up a layout (composite video signal) is given in top left coordinates. The <Width> and <Height> define the size of the frame in pixel values. The VideoSourceId relates to the video/data source currently playing in a frame. All coordinates and sizes are calculated from the assumption that the size of the entire layout is 10000 by 10000 pixels (units). This is because the layout may be presented in different resolutions, e.g. the resolution of the touch screen can be 1024×768 pixels while the resolution of the VCS's 26 output is 1920×1080. By using a fixed unit size in the layout configuration, the layout control unit can calculate the object sizes and position for the graphical representation from the layout configuration measures, and visa versa, without having to consider the resolution of the VCS 26.

FIG. 8 illustrates a computer 1201 upon which an embodiment of the present invention may be implemented. For example, this computer system may be implemented, as part of the video conference system 20, VCS 26, and/or layout control unit 40. The computer system 1201 includes a bus 1202 or other communication mechanism for communicating information, and a processor 1203 coupled with the bus 1202 for processing the information. The computer system 1201 also includes a main memory 1204, such as a random access memory (RAM) or other dynamic storage device (e.g., dynamic RAM (DRAM), static RAM (SRAM), and synchronous DRAM (SDRAM)), coupled to the bus 1202 for storing information and instructions to be executed by processor 1203. In addition, the main memory 1204 may be used for storing temporary variables or other intermediate information during the execution of instructions by the processor 1203. The computer system 1201 further includes a read only memory (ROM) 1205 or other static storage device (e.g., programmable ROM (PROM), erasable PROM (EPROM), and electrically erasable PROM (EEPROM)) coupled to the bus 1202 for storing static information and instructions for the processor 1203.

The computer system 1201 also includes a disk controller 1206 coupled to the bus 1202 to control one or more storage devices for storing information and instructions, such as a magnetic hard disk 1207, and a removable media drive 1208 (e.g., floppy disk drive, read-only compact disc drive, read/write compact disc drive, compact disc jukebox, tape drive, and removable magneto-optical drive). The storage devices may be added to the computer system 1201 using an appropriate device interface (e.g., small computer system interface (SCSI), integrated device electronics (IDE), enhanced-IDE (E-IDE), direct memory access (DMA), or ultra-DMA).

The computer system 1201 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 1201 may also include a display controller 1209 coupled to the bus 1202 to control a display 1210, such as a cathode ray tube (CRT) or LCD display, for displaying information to a computer user. The computer system includes input devices, such as a keyboard 1211 and a pointing device 1212, for interacting with a computer user and providing information to the processor 1203. The pointing device 1212, for example, may be a mouse, a trackball, or a pointing stick for communicating direction information and command selections to the processor 1203 and for controlling cursor movement on the display 1210. In addition, a printer may provide printed listings of data stored and/or generated by the computer system 1201.

The computer system 1201 performs a portion or all of the processing steps in an embodiment of the invention in response to the processor 1203 executing one or more sequences of one or more instructions contained in a memory, such as the main memory 1204. Such instructions may be read into the main memory 1204 from another computer readable medium, such as a hard disk 1207 or a removable media drive 1208. One or more processors in a multi-processing arrangement may also be employed to execute the sequences of instructions contained in main memory 1204. In alternative embodiments, hard-wired circuitry may be used in place of or in combination with software instructions. Thus, embodiments are not limited to any specific combination of hardware circuitry and software.

As stated above, the computer system 1201 includes at least one computer readable medium or memory for holding instructions programmed according to the teachings of the invention and for containing data structures, tables, records, or other data described herein. Examples of computer readable storage media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes. Also, instructions may be stored in a carrier wave (or signal) and read therefrom.

Stored on any one or on a combination of computer readable storage media, the embodiments of the present invention include software for controlling the computer system 1201, for driving a device or devices for implementing the invention, and for enabling the computer system 1201 to interact with a human user. Such software may include, but is not limited to, device drivers, operating systems, development tools, and applications software.

The computer code devices of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

The term “computer readable storage medium” as used herein refers to any physical medium that participates in providing instructions to the processor 1203 for execution. A computer readable storage medium may take many forms, including but not limited to, non-volatile media and volatile media. Non-volatile media includes, for example, optical, magnetic disks, and magneto-optical disks, such as the hard disk 1207 or the removable media drive 1208. Volatile media includes dynamic memory, such as the main memory 1204.

Various forms of computer readable storage media may be involved in carrying out one or more sequences of one or more instructions to processor 1203 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to the computer system 1201 may receive the data on the telephone line and use an infrared transmitter to convert the data to an infrared signal. An infrared detector coupled to the bus 1202 can receive the data carried in the infrared signal and place the data on the bus 1202. The bus 1202 carries the data to the main memory 1204, from which the processor 1203 retrieves and executes the instructions. The instructions received by the main memory 1204 may optionally be stored on storage device 1207 or 1208 either before or after execution by processor 1203.

The computer system 1201 also includes a communication interface 1213 coupled to the bus 1202. The communication interface 1213 provides a two-way data communication coupling to a network link 1214 that is connected to, for example, a local area network (LAN) 1215, or to another communications network 1216 such as the Internet. For example, the communication interface 1213 may be a network interface card to attach to any packet switched LAN. As another example, the communication interface 1213 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 1213 sends and receives electrical, electromagnetic or optical signals that carry digital data streams representing various types of information.

The network link 1214 typically provides data communication through one or more networks to other data devices. For example, the network link 1214 may provide a connection to another computer through a local network 1215 (e.g., a LAN) or through equipment operated by a service provider, which provides communication services through a communications network 1216. The local network 1214 and the communications network 1216 use, for example, electrical, electromagnetic, or optical signals that carry digital data streams, and the associated physical layer (e.g., CAT 5 cable, coaxial cable, optical fiber, etc). The signals through the various networks and the signals on the network link 1214 and through the communication interface 1213, which carry the digital data to and from the computer system 1201 maybe implemented in baseband signals, or carrier wave based signals. The baseband signals convey the digital data as unmodulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase and/or frequency shift keyed signals that are propagated over a conductive media, or transmitted as electromagnetic waves through a propagation medium. Thus, the digital data may be sent as unmodulated baseband data through a “wired” communication channel and/or sent within a predetermined frequency band, different than baseband, by modulating a carrier wave. The computer system 1201 can transmit and receive data, including program code, through the network(s) 1215 and 1216, the network link 1214 and the communication interface 1213. Moreover, the network link 1214 may provide a connection through a LAN 1215 to a mobile device 1217 such as a personal digital assistant (PDA) laptop computer, or cellular telephone.

Numerous modifications and variations of the present invention are possible in light of the above teachings. It is therefore to be understood that within the scope of the appended claims, the invention may be practiced otherwise than as specifically described herein.

1. A method for modifying a composite video signal generated by a video composing server, the composite video signal including a plurality of spatially mixed video conference streams, the method comprising:
displaying, on a touch screen, a graphical representation of the composite video signal;
modifying the graphical representation based on an input received at the touch screen; and
modifying the composite video signal to conform with the modified graphical representation.

2. The method according to claim 1, wherein
the graphical representation includes a plurality of graphical objects, which each represent one of said video conference streams, and are arranged in a corresponding order and corresponding relative positions and sizes on the touch screen, and
the composite video signal is modified to conform to the modified graphical representation when the video conference streams are spatially mixed according to the order and/or position and/or size of the graphical objects on the modified graphical representation on the touch screen.

3. The method according to claim 2, wherein:
modifying the graphical representation includes modifying the order and/or position and/or size of one or more of said plurality of graphical objects.

4. The method according to claim 1, wherein the displaying further comprises:
receiving, from the video composing server, a layout configuration indicating a layout of the composite video signal; and
generating the graphical representation based on the layout configuration.

5. A method according to claim 1, wherein modifying further comprises:
generating a layout configuration based on the order and/or position and/or size of the graphical objects on the touch screen; and
sending a command to the video composing server, instructing the video composing server to modify the composite video signal according to the layout configuration.

6. The method according to claim 5, wherein:
the sending of the layout configuration is performed over a TCP/IP connection using Application Programming Interface (API) signals.

7. The method according to claim 2, wherein the modifying further comprises:
removing one or more of the graphical objects or adding a graphical object.

8. The method according to claim 7, further comprising:
placing the video conference stream on hold when a graphical object representing the video conference stream is removed from the graphical representation.

9. The method according to claim 1, wherein:
the graphical representation includes a border line representing an outer boundary of the composite video signal, and
removing a graphical object is performed by dragging and dropping at least parts of a graphical objects outside the border line.

10. A layout control apparatus for modifying a composite video signal generated by a video composing server, the composite video signal including a plurality of spatially mixed video conference streams, the layout control apparatus comprising:
a touch screen configured to display a graphical representation of the composite video signal;
a control unit configured to modify the graphical representation based on an input received at the touch screen; and
a processor configured to control an communication interface to send an instruction signal to the video composing server to modify the composite video signal to conform with the modified graphical representation.

11. The layout control apparatus according to claim 10, wherein
the graphical representation includes a plurality of graphical objects, which each represent one of said video conference streams, and are arranged in a corresponding order and corresponding relative positions and sizes on the touch screen, and
the instruction signal instructs the composite video signal to be modified to conform to the modified graphical representation when the video conference streams are spatially mixed according to the order and/or position and/or size of the graphical objects on the modified graphical representation on the touch screen.

12. The layout control apparatus according to claim 11, wherein the touch screen is configured to receive an input modifying the order and/or position and/or size of one or more of said plurality of graphical objects.

13. The layout control apparatus according to claim 10, further comprising:
a communication interface configured to receive, from the video composing server, a layout configuration indicating a layout of the composite video signal, wherein the touch screen is configured to generate the graphical representation based on the layout configuration.

14. The layout control apparatus according to claim 10, wherein:
the processor is configured to generate a layout configuration based on the order and/or position and/or size of the graphical objects on the touch screen; and
the communication interface is configured to send a command to the video composing server instructing the video composing server to modify the composite video signal according to the layout configuration.

15. The layout control apparatus according to claim 10, wherein:
the communication interface is configured to communicate with the video composing server over a TCP/IP connection using Application Programming Interface (API) signals.

16. The layout control apparatus according to claim 10, wherein the modifying includes removing one or more of the graphical objects or adding a graphical object.

17. The layout control apparatus according to claim 16, wherein the processor is configured to instruct the video conference stream to be put on hold when a graphical object representing the video conference stream is removed from the graphical representation.

18. The layout control apparatus according to claim 10, wherein:
the graphical representation includes a border line representing an outer boundary of the composite video signal, and
removing a graphical object is performed by dragging and dropping at least parts of a graphical objects outside the border line.

19. A non-transitory computer readable medium including computer program instructions, which when executed by a computer, cause the computer to perform a method for modifying a composite video signal generated by a video composing server, the composite video signal including a plurality of spatially mixed video conference streams, the method comprising:
displaying, on a touch screen of the computer, a graphical representation of the composite video signal;
modifying the graphical representation based on an input received at the touch screen; and
modifying the composite video signal to conform with the modified graphical representation.
